(19) United States
(12) Patent Application Publication
(10) Pub. No.: US 2005/0276366 A1
(43) Pub. Date: Dec. 15, 2005

(54) Low temperature nuclear fusion

(75) Inventor: John Dash, Portland, OR (US)

Correspondence Address: KLARQUIST SPARKMAN, LLP;One World Trade Center, Suite 1600, 121 S.W. Salmon Street, Portland, OR, 97204, US

(73) Assignee: Electrochemical Innovations, Inc.

(21) Appl. No.: 10/616,165

(22) Filed: Jul. 7, 2003

Related U.S. Application Data
(63) Continuation of application No. 08/748,183, filed on Nov. 12, 1996, now abandoned.
Application No. 08/748,183 is a continuation-in-part of application No. 08/439,712, filed on May 12, 1995, now abandoned.

(51) Int. Cl. G21J 1/00; G21B 1/00

(52) U.S. Cl. 376/100

(57) ABSTRACT

A method of producing energy is described. The method comprises providing a container for receiving an electrolyte composition, a cathode and an anode. An electrolyte composition is formed comprising D₂O and an ionizable acid. A sufficient amount of the electrolyte composition is placed in the container to at least partially cover a cathode made from a metal selected from the group consisting of nonhydride forming metals and to at least partially cover an inert anode situated inside the container. The cathode and anode are connected to a source of electricity, and a voltage is applied across the cathode and anode. The present invention can be used to reproducibly produce heat energy.

### CROSS REFERENCE TO RELATED APPLICATION

This is a continuation-in-part of U.S. patent application Ser. No. 08/439,712, filed on May 12, 1995, entitled LOW TEMPERATURE NUCLEAR FUSION (parent application). The parent application is incorporated herein by reference.

### FIELD OF THE INVENTION

This invention concerns the production of energy through electrochemical charging of a cathode made from a metal selected from the group consisting of nonhydride forming metals, such as palladium, platinum and titanium, with deuterium or heavy hydrogen being formed by an electrolysis process.

### BACKGROUND OF THE INVENTION

It has been reported by Fleischmann, Pons and Hawkins that prolonged electrochemical charging of a palladium cathode with deuterium formed by electrolysis of a D₂O solution containing LiOD leads to the evolution of neutrons and tritium together with heat on a scale not reconciled with any known chemical reaction. Difficulties have been experienced in confirming the results of these investigators.

### SUMMARY OF THE INVENTION

The present invention can be used to reproducibly produce heat energy. The invention is based on the observation that significant amounts of energy in the form of heat and the production of a radioactive material, i.e., tritium, is obtained in a reliable manner through electrolysis using an electrolyte comprising D₂O and an ionizable acid, such as sulfuric acid. With a current passed through the electrolyte employing an inert anode, such as a platinum anode, and a cathode made from a metal selected from the group consisting of nonhydride forming metals, such as palladium, platinum and titanium, deuterium and hydrogen atoms are formed at the cathode. It is postulated that these react in an unknown nuclear reaction in the cathode to yield tritium and energy.

The invention further contemplates performing the process of the invention in an environment wherein gases produced by the electrolysis recombine under the action of a catalyst in a region disposed above the region where the electrolyte is contained. With hydrogen and deuterium formed at the cathode and oxygen formed at the anode, these recombine in the presence of a catalyst, such as platinum-black, to form water and heavy water. The recombining of these gases in this fashion constitutes an important safety feature. The gases may also be collected for industrial uses, in which case, the catalyst is not needed.

These and other objects and advantages are attained by the invention, which is described hereinbelow in conjunction with the accompanying FIGS. 1-4.

### BRIEF DESCRIPTION OF THE DRAWINGS

FIG. 1 is a schematic drawing illustrating equipment which may be utilized in performing the process of the invention.

FIG. 2 is graph illustrating time versus temperature for a energy producing cell having a titanium cathode versus a control cell having a platinum cathode.

FIG. 3 is graph illustrating time versus power input to an energy producing cell having a titanium cathode versus a control cell having a platinum cathode.

FIG. 4 is an EDS spectra of a titanium cathode used in a cell such as illustrated in FIG. 1.

FIG. 5 is an EDS spectra of a titanium cathode used in a cell such as illustrated in FIG. 1.

### DETAILED DESCRIPTION OF THE PREFERRED EMBODIMENTS

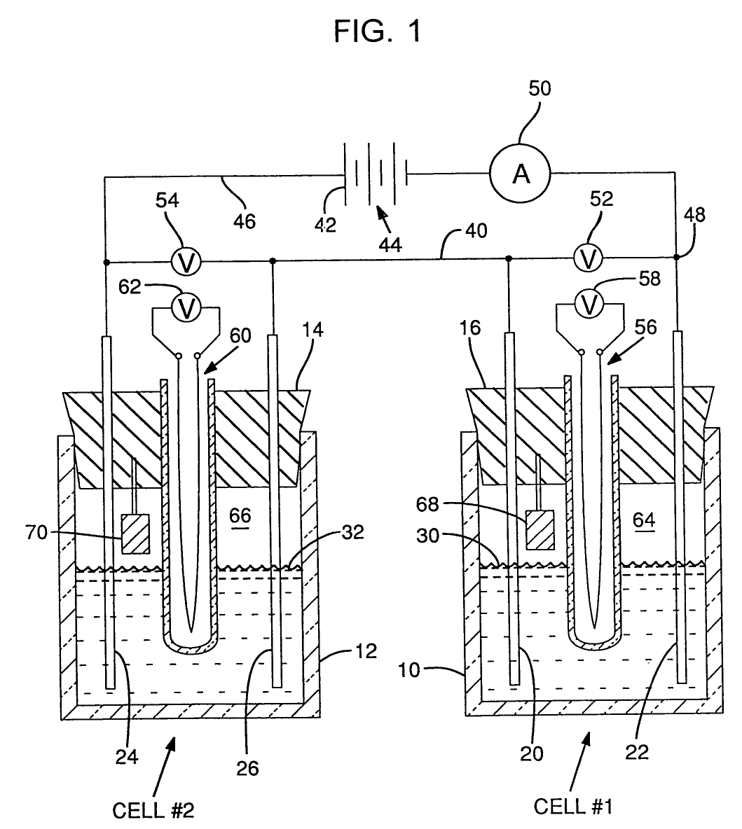

Referring to FIG. 1. indicated at 10 and 12 are a pair of containers which are inert to a mixture of sulfuric acid and deuterated water, i.e., heavy water. These containers, for instance, may take the form of glass beakers. Closing off the tops of the containers and providing a mounting for elements residing within the containers are stoppers shown at 14 and 16.

Within each container an anode and a cathode are provided, and such are indicated for container 10 at 20 and 22, and for container 12 at 24 and 26, respectively. Cathodes 22, 26 are made from metals selected from the group consisting of nonhydride forming metals, more specifically from the group consisting of palladium, platinum and titanium. The embodiment illustrated in FIG. 1 used cold-rolled palladium for making the cathode. Anodes 20, 24 are of platinum.

As will be described, an electrolyte is placed within container 10, such being indicated at 30, to produce an electrolytic cell which is indicated in FIG. 1 as cell #1. Electrolyte also is placed within container 12, shown at 32, to produce from this container and its anode and cathode another electrolytic cell, indicated in FIG. 1 as cell #2.

Connecting anode 20 of cell #1 with cathode 26 of cell #3 is a conductor 40. Connecting the anode of cell 2 with the anode 42 of a power source 44 is a conductor 46. Connecting the cathode of power source 44 with cathode 22 of cell 1 is a conductor 48. Current flow of conductor 48 is determined with ammeter 50. The voltage impressed across each cell is determined by voltmeters 52 and 54. With the construction described, the two cells are connected in series between the anode and the cathode of the power source.

Shown at 56 is a thermocouple which is effective to measure the temperature of the electrolyte in cell 1 and produce, in voltage measuring instrument 58, a voltage indication which is related to the temperature of the electrolyte. Similarly, shown at 60 is a thermocouple effective to determine the temperature of the electrolyte in cell 2. Voltage-measuring instrument 62 produces a voltage rating which is related to the temperature level of this electrolyte.

During the electrolysis of the electrolyte within the two cells gases tend to be produced at the electrodes. In the case of cell 1, where the electrolyte is principally heavy water and sulfuric acid, these gases are deuterium and hydrogen at the cathode and oxygen at the anode. In the case of cell 2, wherein the electrolyte is regular water and sulfuric acid, the gases are hydrogen at the cathode and oxygen at the anode. These gases tend to collect in the space above the electrolyte, indicated in FIG. 1 for cell 1 by space 64, and in cell 2 by space 66.

A catalyst is suspended in these spaces to promote recombining of these gases and to minimize explosive, unsafe conditions. Thus, a platinum-black catalyst is shown at 68 suspended in space 64 and providing a region where such a combination can take place speedily and safely. In the case of space 66, the catalyst is shown at 70.

The following examples are provided solely to illustrate certain features of the present invention. The invention should not be limited to the particular features exemplified.

### EXAMPLE 1

Describing an energy producing electrolysis utilizing the equipment described, an electrolyte comprising a mixture of twenty ml. of water and 3.5 ml. of concentrated sulfuric acid was placed in cell 2. The sulfuric acid was analytical grade, with a specific gravity of 1.84. An electrolyte was prepared and placed in cell 1 comprising twenty ml. of D₂O (99.75 percent heavy water) and also 3.5 ml of concentrated sulfuric acid.

In the electrolysis, a voltage of about 3.5 volts was applied across each cell. Because of the greater resistivity of the electrolyte in the heavy water cell, or cell 1, a platinum anode having three times the cross-sectional area of the anode utilized in cell 2 was employed. The size of the cathodes in the two cells were the same, i.e., 1 cm². The electrodes were cut from sheets of material.

Voltage was applied across the cells for a period of five days, throughout this time the voltage drop across each cell remained the same, i.e., about 3.5 volts.

At the end of the five-day period, it was calculated from observations made that the energy produced at the heavy water cell, i.e., cell 1 was twenty-five percent greater than the energy produced at the regular water cell, i.e., cell 2. This heat energy was calculated knowing the specific heats of the electrolytes in the two cells, the loss of energy to the environment through heat conduction, the time of the electrolysis, and the temperature levels in the two cells as determined by the thermocouples described.

Tritium is an isotope of hydrogen having a mass of three. Tritium is radioactive and has a half-life of 12.5 years.

The production of tritium in the electrolyte containing heavy water and sulfuric acid and the lack of any production of such material in the electrolyte comprising water and sulfuric acid was determined by liquid scintillation techniques. In this procedure, a test sample is prepared by mixing a certain amount of the solution to be analyzed with a liquid scintillation counting medium or “cocktail.” The radioactivity of the test sample is determined using a scintillation counter. Excited liquid gives off photons, and these photons are counted with the scintillation counter.

Thirteen different test samples were evaluated utilizing liquid scintillation. Three of these were samples prepared with the electrolyte of cell 2 before the electrolysis, and three were prepared from the electrolyte of cell 2 after the electrolysis. In the table below, the three samples prepared from the electrolyte before electrolysis from cell 2 are indicated as H1B, H2B, and H3B. The three samples prepared from the electrolyte after electrolysis are indicated as H4A, H5A, and H6A. Also analyzed were three samples prepared with the electrolyte of cell 1 before electrolysis, referred to in the table below as D1B, D2B, and D3B, and three samples prepared from the electrolyte of cell 1 after the electrolysis, identified in the table below as D4A, D5A, and D6A. A thirteenth “control” sample, identified in the table as M.T., contained only the cocktail with no electrolyte from any of the cells added.

In preparing a sample, each was prepared by mixing ten ml. of the cocktail with 0.5 ml. of the particular electrolyte which made up the sample.

The liquid scintillation counting medium used was one produced by Isolab, Inc. of Akron, Ohio, sold under the trademark “Solvent-Free.”

Table 1 below summarizes the counts per minute that were noted in the various samples tested.

TABLE 1

| | Test Sample: | | | | | | | | | | | | |
|---|---|---|---|---|---|---|---|---|---|---|---|---|---|
| | M.T. | H1B | H2B | H3B | H4A | H5A | H6A | D1B | D2B | D3B | D4A | D5A | D6A |
| C.P.M.: | 11.42 | 12.20 | 12.36 | 11.85 | 11.41 | 12.34 | 11.84 | 32.38 | 26.10 | 36.48 | 49.14 | 49.54 | 49.58 |

It will be noted from the results summarized above, that the control and the samples containing cocktail and a small amount of the electrolyte from cell 2, both before and after the electrolysis, exhibited a counts per minute in the scintillation counter which were substantially the same and within the range of approximately 11.4 to 12.4. On the other hand, it will be noted that the samples prepared from the electrolyte containing heavy water processed before the electrolysis exhibited a counts per minute in the range of twenty-six through thirty-six. After the electrolysis, the counts per minute noted in the three samples sharply increased, with all three samples tested exhibiting a counts per minute in the counter exceeding forty-nine.

### EXAMPLE 2

This example describes the use of a titanium cathode, instead of a palladium cathode as with example 1, in an energy producing system. Pure titanium foil (0.25 mm thick, 99.99+% Ti) was spotwelded to platinum lead wire and made the cathode in an electrolytic cell with a platinum anode and 15 ml of electrolyte containing 0.01 mol fraction H₂SO4 (reagent) and 0.99 mol fraction D₂O (99.9 atom % D). Recombination catalyst (platinized Al₂O₃) was suspended above the electrolyte, and the cell was sealed. An identical cell containing a platinum cathode was connected in series. This cell was used as a control to measure heat effects by comparison with the titanium-cathode cell. An automated data acquisition system monitored cell voltages, six thermocouples that were attached to each cell and the ambient temperature. Constant current was used during the experiments.

Using a constant current of 0.55 A resulted in current density of about 2 A per square cm on the titanium cathode. This current was passed for about 33.5 hours.

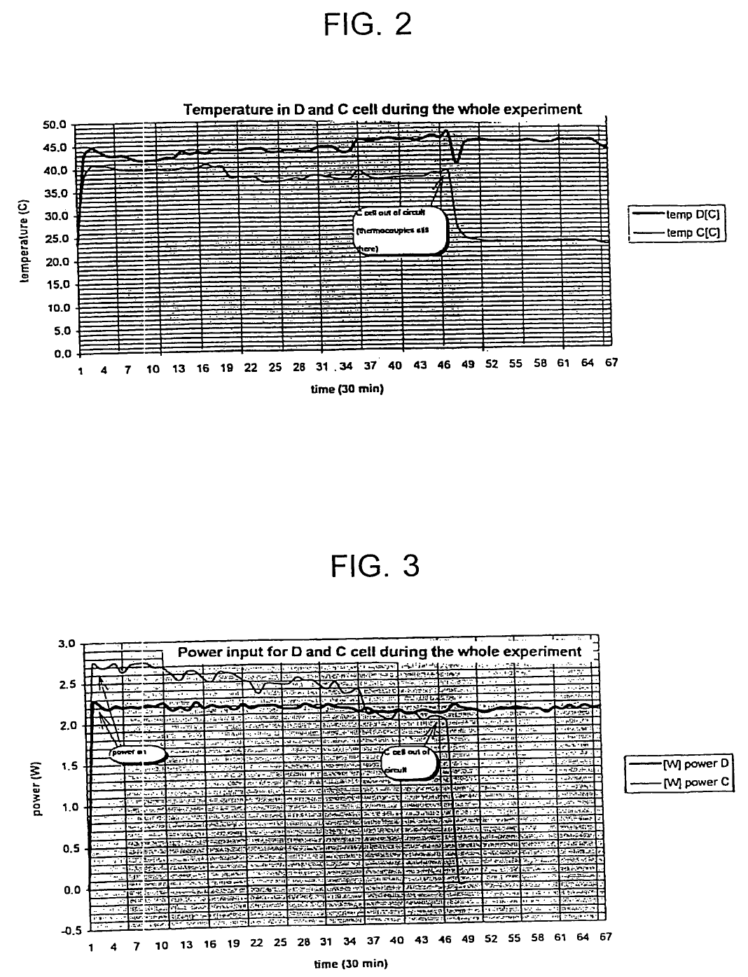

The resulting power input and temperature-time data for each cell are shown in FIGS. 2 and 3. It should be noted that the control (C) cell was taken out of the circuit after about 23 hours, due to excessive loss of electrolyte.

FIG. 2 shows that the temperature of the titanium (D) cell exceeded that of the platinum control (C) cell. FIG. 3 shows that the power input to the C cell clearly exceeded the power input to the D cell during the first 18 hours. Excess heat appeared to be produced by the D cell. This can be calculated by considering the power input, the heat produced by the combination of titanium with hydrogen isotopes, losses due to escape of gases through the tops of the cells, and the heat loss to the environment due to the thermal gradient between the cells and the surroundings.

The following equations give the rate of enthalpy change in each cell:

$$\begin{matrix}ⅆ H ( C ) / ⅆ t = IV ( C ) - ⅆ H ( Cesc ) / ⅆ t - R Δ T ( C ) & C ( control ) Cell \\ ⅆ H ( D ) / ⅆ t = IV ( D ) + ⅆ H ( TiD ) / ⅆ t + ⅆ H ( XS ) / ⅆ T - ⅆ H ( Desc ) / ⅆ t - R Δ T ( D ) , & D ( experimental ) cell\end{matrix}$$

where (1) H(C) and H(D) are each the enthalpy of the C and D cells, respectively; (2) H(TiD) is the enthalpy released by formation of TiD; (3) H(Cesc) and H(Desc) are each the enthalpy which escapes from its respective cell due to incomplete recombination; (4) H(XS) is the excess enthalpy produced in the D cell; (5) I is the constant current which passed through both cells; (6) V(C) and V(D) are the cell voltages; (7) R is the rate of heat loss by each cell to the surroundings; and (8) ΔT(C) and ΔT(D) are the temperature differences between each cell and the ambient temperature.

At steady state, which was reached in about 45 minutes, the enthalpy gain equals the enthalpy loss for each cell, so each equation can be set equal to zero. The enthalpy lost due to escape of gases is determined from the weight lost be each cell. For the C cell, this was 285 calories for the whole experiment (23 hours for the C cell), which gives dH(Cesc)/dt equal to 0.0034 calories per second. The average power input to the C cell during one hour at steady state, IV(C), was 0.644 calories per second. Then the first equation is solved for R, using ΔT(C) of 16.5C. This gives R equal to 0.0388 calories per degree C. This is used in the second equation.

About 40 calories are produced by conversion of the entire titanium cathode to TiD. As a result, dH(TiD)/dt is about 0.0003 calories per second IV(D) is 0.525 calories per second, dH(Desc)/dt is 0.0012 calories per second, or 1.15 watt.

Geiger-Mueller counters were used to monitor radiations from the C and D cells throughout the experiment, and LiF chips sealed in plastic were in each cell during the experiment. The counters showed slightly higher amounts of radiation coming from the D cell.

The titanium cathode was examined before and after electrolysis with SEM and EDS. Before each examination, the electrode was cleaned ultrasonically several times, each time for 5 minutes with deionized water. Many changes in the topography of the cathodes were noted. Certain regions of change in the topography were examined in detail at higher magnification, showing that cracking occurred along the edge of the sample.

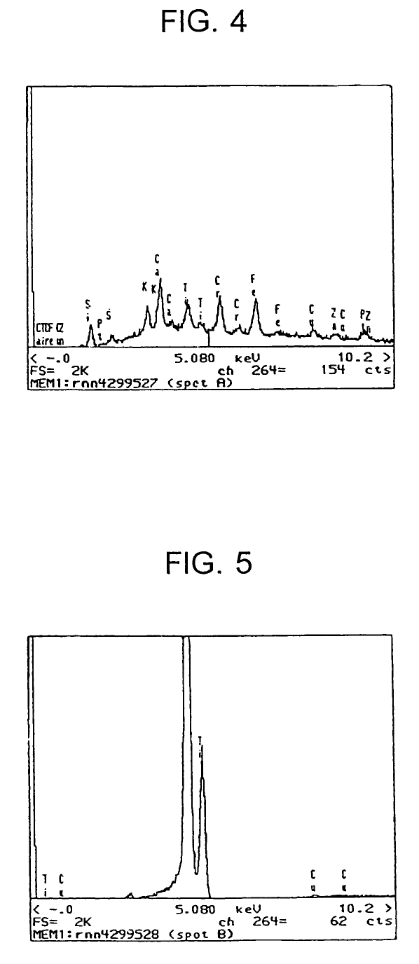

EDS spectra were taken of those cathode regions experiencing topographical changes. FIG. 4 shows the presence of many elements of both higher and lower atomic number than titanium. The concentrations of these element is far higher than can be expected from the composition of the original material. In contrast, FIG. 5, which is an EDS spectra from a cathode region not experiencing large topographical changes, showed that the cathode remained almost pure titanium.

### EXAMPLE 3

This example describes an experiment similar to that described in Example 2. However, in this experiment the current density was about 0.5 A/sq. cm instead of 2 A/sq. cm. The excess heat produced by this cell was about 0.5 watt for a titanium electrode from the same lot, and having about the same mass, as that used in Example 2. The cathode used in this Example 3 also was examined with SEM and EDS

The results obtained with thin foil titanium cathodes are similar to those obtained with cells such as those described in Example 1 wherein palladium cathodes were used with an electrolyte comprising H₂SO₄ and D₂O. That is, (1) excess heat and (2) unexpected elements are produced reproducibly. However, a significant difference is observed when titanium cathodes are used, i.e., excess heat is observed from the onset of electrolysis with titanium cathodes, whereas there appears to be an “incubation” period for cells using palladium cathodes. This incubation period is dependent upon a number of factors, including the thickness of the foil used to make the cathode. For a palladium foil being about 0.025 mm thick, the incubation period appears to be about 1 hour, whereas with a palladium cathode having a thickness of about 0.1 mm, the incubation period is about 24 hours. Moreover, the magnitude of the excess heat produced appears to be greater for cells using titanium cathodes than it does for cells using palladium cathodes under otherwise identical circumstances.

The EDS spectra also indicate the presence of chromium and vanadium. It is likely that such spectra contain both chromium and vanadium because of the overlap between V Kbeta with Cr Kalpha. The chemical analysis provided by the supplier of the titanium metal used to make the cathode showed 0.910 ppm vanadium and 1.150 ppm chromium. The EDS spectra of the cathode following electrolysis showed concentrations of these metals that were more than four orders of magnitude higher.

The production of heat and the radioactivity in the materials processed according to the invention are consistent with the postulate that a nuclear reaction has taken place with the production of energy.

The present invention has been described with reference to preferred embodiments. It should be understood that certain modifications may be made thereto without departing from the invention. I claim as my invention the embodiments described herein and all such modifications and equivalents as come within the true spirit and scope of the following claims.

1. A method of producing heat energy, comprising the steps of:
providing a container for receiving an electrolyte composition, a cathode and an anode;
forming an electrolyte composition comprising D₂O and [an ionizable acid] sulfuric acid;
placing a sufficient amount of the electrolyte composition in the container to at least partially cover a cathode made from a metal selected from the group consisting of [nonhydride forming metals] palladium, platinum and titanium and to at least partially cover an inert anode situated inside the container;
connecting the cathode and anode to a source of electricity; and
applying a [voltage] current density across the cathode and anode of at least 0.55 A/cm².

2. (canceled)

3. The method of claim 1 wherein the electrolyte during the application of voltage is held within a container and wherein said container bounds a space above the electrolyte, said space providing a region for the recombining of gases produced during the electrolysis.

4. The method of claim 1 wherein a catalyst is provided within said region catalyzing the recombining of gases produced by the electrolysis.

5. The method according to claim 1 wherein the cathode is made from palladium.

6. The method according to claim 5 wherein the size of the cathode is about 1 cm².

7. The method according to claim 1 wherein the cathode is made from titanium.

8. The method according to claim 1 wherein the inert anode is a platinum anode.

9. The method according to claim 1 wherein the electrolyte composition consists essentially of D₂O and about 15% sulfuric acid by volume.

10. The method according to claim 9 wherein the cathode is made from palladium or titanium.

11. A method of producing heat energy, comprising the steps of:
providing a container for receiving an electrolyte composition, a cathode and an anode;
forming an electrolyte composition comprising D₂O and sulfuric acid;
placing a sufficient amount of the electrolyte composition in a container to at least partially cover a cathode made from a metal selected from the group consisting of nonhydride forming metals and to at least partially cover an inert anode situated inside the container;
connecting said cathode and anode to a source of electricity; and
applying a voltage of about 3.5 volts across the cathode and anode.

12. A method of producing heat energy, comprising the steps of:
providing a container for receiving an electrolyte composition, a cathode and an anode;
forming an electrolyte composition consisting essentially of D₂O and 15% by volume sulfuric acid;
placing a sufficient amount of the electrolyte composition in a container to at least partially cover a palladium or titanium cathode and an inert anode situated inside the container, wherein the container bounds a space above said electrolyte composition;
connecting said cathode and anode to a source of electricity;
applying a voltage across the cathode and anode; and
providing a catalyst within the space above the electrolyte composition to catalyze the recombination of gases produced by the electrolyte.
